(19) United States
(12) Patent Application Publication
(10) Pub. No.: US 2013/0282618 A1
(43) Pub. Date: Oct. 24, 2013

(54) METHOD AND PROCESS FOR INTERACTIVELY DISPLAYING AND RESEARCHING INVESTMENT INFORMATION

(71) Applicant: Franklin Templeton Investments, San Mateo, CA (US)

(72) Inventor: Matt Dunn, San Mateo, CA (US)

(21) Appl. No.: 13/869,508

(22) Filed: Apr. 24, 2013

Related U.S. Application Data
(60) Provisional application No. 61/637,488, filed on Apr. 24, 2012.

(51) Int. Cl. G06Q 40/06

(52) U.S. Cl. CPC G06Q 40/06
USPC 705/36 R

(57) ABSTRACT

An inventive business method and process operated and presented using computer software comprises an interactive marketing and information retrieval system which may, in a preferred embodiment, be used to provide a wide range of information about financial investments, and to market financial investment products and services. The inventive method uses various creative tools to present detailed investment information about different investment funds, including fund overview, portfolio, and performance. In a preferred embodiment, the method and process uses a look-and-feel of the periodic table of elements to organize, structure and present information about available investment funds. The method and process also allows users to interactively select and access fund and investment information, which may include information presented through webcasts or video-streaming. In a preferred embodiment, the method and process may further provide an interactive personalized user portfolio or “briefcase” showing the user's individual investment portfolio or selected fund or financial information.

### CROSS REFERENCE TO RELATED APPLICATIONS

This application claims priority to U.S. Provisional Application No. 61/637,488, filed on Apr. 24, 2012, the contents of which are incorporated by reference herein, in their entirety and for all purposes.

### FIELD OF THE INVENTION

The present invention relates generally to methods and systems for retrieving, reviewing and displaying investment information, and in more particularity, to methods and systems for retrieving, reviewing, researching, analyzing and displaying, in innovative display presentations, financial investment information. More specifically, the present invention relates to methods and systems for displaying investment information using creative display formats, including a look-and-feel similar to the period table of elements and using color coding to readily distinguish between investment categories.

### BACKGROUND OF THE INVENTION

Financial professionals and investors alike are always seeking ways to easily review, research, digest and analyze investment information. Such users have ready access today to reams of financial and investment information. Unfortunately, such information is most often displayed in a format that makes review and analysis exceedingly difficult. The ability to filter, select, drill down, and easily identify types of asset categories or funds of interest are not readily available or in use. Moreover, innovative use of display look-and-feel, display color, and display format, along with system architecture permitting users to intuitively access further detail or specific fund information has not been achieved. What is needed is an innovative method and system, using creative displays to allow users to easily view, access, retrieve, and analyze investment information and data. Such displays should be available through common wireless devices such as tablets, smart phones, laptops, as well as with desktop computers.

### SUMMARY OF THE INVENTION

The inventive methods and systems use real-time computer processors executing particular software to provide users with an innovative display of investment information and allow users to easily retrieve, review and analyze investment information and data. The present invention overcomes the limitations and problems with prior art methods and fulfills the needs described above by providing a method, process and system for innovatively displaying to users various investment information, thereby providing users with a ready means for accessing, reviewing, researching, and analyzing selected investment information.

More specifically, a preferred embodiment of the present invention is an interactive computerized method for displaying and analyzing investment information relating to investment funds, using at least one computer processor, and at least one database communicatively connected to the at least one computer processor, the method comprising the steps of (a) identifying a plurality of investment funds to be displayed, with said plurality of investment funds each having related investment fund data and information; (b) uploading said plurality of investment fund data and information to the at least one database; (c) organizing said plurality of investment fund data and information into a plurality of displays, including a fund home page; (d) displaying said plurality of investment fund data and information organized in said plurality of displays in an interactive format; (e) selecting at least one filter relating to said plurality of investment funds; (f) applying said selected at least one filter relating to the investment funds; and (g) updating said plurality of displays based upon the selected and applied at least one filter relating to the investment funds.

Another preferred aspect of the present invention is an interactive marketing and information retrieval system for use in displaying and analyzing investment information relating to investment funds, comprising at least one computer processor; and at least one database communicatively connected to the at least one computer processor; wherein said at least one computer processor executes the following method steps (a) identifying a plurality of investment funds to be displayed, with said plurality of investment funds each having related investment fund data and information; (b) uploading said plurality of investment fund data and information to the at least one database; (c) organizing said plurality of investment fund data and information into a plurality of displays, including a fund home page; (d) displaying said plurality of investment fund data and information organized in said plurality of displays in an interactive format; (e) selecting at least one filter relating to said plurality of investment funds; (f) applying said selected at least one filter relating to the investment funds; and (g) updating said plurality of displays based upon the selected and applied at least one filter relating to the investment funds.

Other features and advantages of the present invention are described in the following detailed description of the invention, which refers to the accompanying drawings as described herein.

### BRIEF DESCRIPTION OF THE DRAWINGS

The drawings and figures, which form a part of this specification, include the following:

FIG. 1 illustrates an example process flowchart for a preferred embodiment of the inventive methods, processes and systems for research and display of investment information;

FIG. 2 illustrates an exemplary embodiment of an interactive input/output home page display for the methods and processes for research and display of investment information;

FIG. 3 illustrates an exemplary embodiment of an interactive input/output display showing, in a periodic table of elements format, available investment funds, a fund home page, that can be selected and/or researched;

FIG. 4 illustrates an exemplary embodiment of an interactive input/output display window, showing a listing of a particular fund category as selected from the exemplary FIG. 3 display;

FIG. 5 illustrates an exemplary embodiment of an interactive input/output display showing a window for selecting potential fund research filters;

FIG. 6 illustrates an exemplary embodiment of an interactive input/output display showing a continuation of the window from FIG. 5, for selecting potential fund research filters;

FIG. 7 illustrates an exemplary embodiment of an interactive input/output display showing the results of selecting the “fixed income” asset category;

FIG. 8 illustrates an exemplary embodiment of an interactive input/output display showing the detailed results for a particular selected fund, showing the fund overview;

FIG. 9 illustrates an exemplary embodiment of an interactive input/output display showing the detailed results for a particular selected fund, showing the fund performance;

FIG. 10 illustrates an exemplary embodiment of an interactive input/output display showing the detailed results for a particular selected fund, particularly showing an example drop-down window for available share class selections; and

FIG. 11 illustrates an exemplary embodiment of an interactive input/output display showing the detailed results for a particular selected fund, particularly showing example fund details including asset allocation, portfolio breakdown and top holdings.

### DETAILED DESCRIPTION OF PREFERRED EMBODIMENTS OF THE INVENTION

The present invention is a method, process, and system using computer software, one or more computer processors, and related databases, to provide an interactive marketing and information retrieval system which may, in a preferred embodiment, be used to provide a wide range of information about financial investments, and to market financial investment products and services. The inventive method uses various innovative and creative tools to present detailed investment information about different investment funds, including data and information relating to fund(s) overview, portfolio details, and fund historical performance. In one particular preferred embodiment, as described below, and illustrated in the attached drawings, the method, process, and system uses a home page display look-and-feel that is similar to the periodic table of elements to systematically organize, structure and present information about available investment funds.

In preferred embodiments, the methods, processes, and systems may also allow users to interactively research and retrieve fund and investment information. Such information may include research information that can be presented through, by way of example, streaming webcasts, video-streaming, and/or live investor “chats.” As further detailed in this application, in a preferred embodiment, the inventive method and process may also provide the user with the ability to create an interactive personalized user portfolio or “briefcase” showing the user's individual investment portfolio, or simply display investment funds or information of interest to the user.

The inventive method and process is designed to permit the user to quickly and easily access, research and retrieve various fund data and information, including basic overview information, detailed fund information and/or portfolio allocations. In a preferred embodiment, the inventive display and retrieval system may be implemented to be accessible through wireless, mobile devices, such as a tablet or smartphone. The inventive method and process is not however limited to only being used on such type of mobile devices, and is intended to be accessible and used through any computerized system and device having an interactive display.

### Method and Process Flow

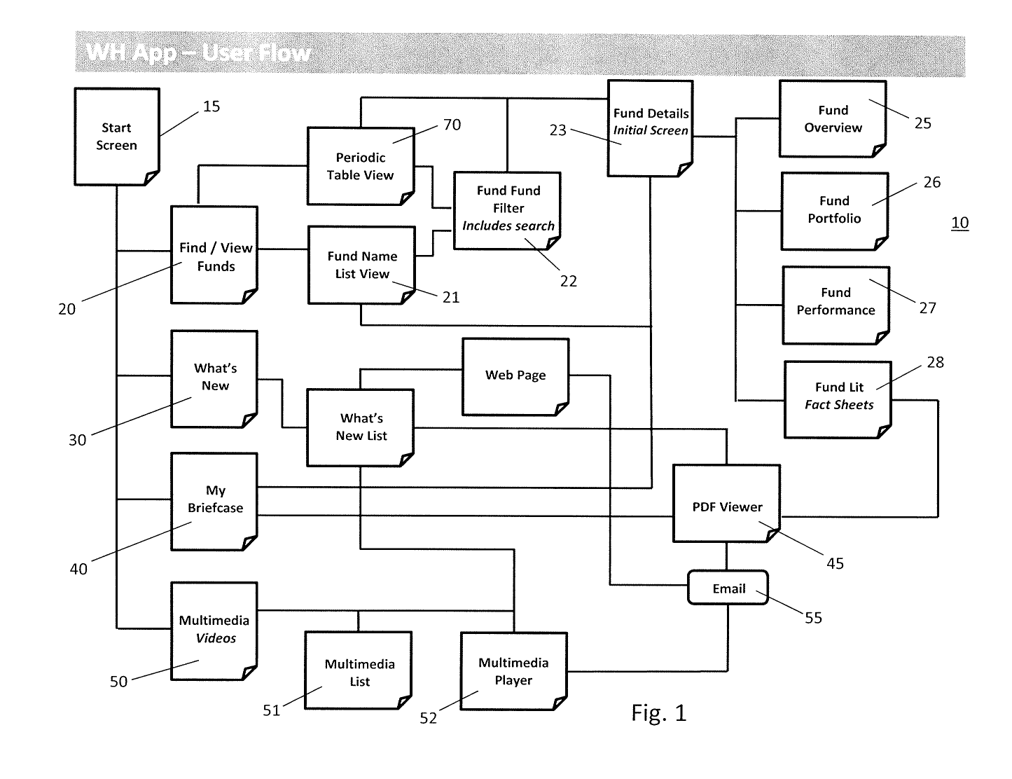

As shown in FIG. 1, in a preferred embodiment, the inventive method and process 10 uses an interrelated flow and interconnection of information relating to the investment funds, along with the user's access and ability to retrieve that information. The FIG. 1 method and system 10 flowchart shows that from a start screen 15, shown in the upper left hand corner of the flowchart, the user has access to, and can retrieve information from any of four “folders” of investment information: (1) “find/view funds 20;” (2) “what's new 30;” (3) “my briefcase 40;” and (4) “multimedia 50.”

From the “find/view funds” folder 20, the user is then able to access a “fund name” listing view 21, or a graphical “periodic table” view 70 of the various funds for which information is maintained in the system database. As shown in FIG. 1, the user is also able to conduct different searches, through a “fund filter” 22, relating to the funds available. Such searches could, in a preferred embodiment, permit the user to filter funds by (a) asset category, including for example value or growth funds; (b) fund family; (c) share class; and/or (d) fund ratings.

Through the several fund filters, the user is able to readily access and review details about any of the funds, or the particular funds retrieved through the search results. As shown in FIG. 1, such details about the various funds may include (a) fund overview 25; (b) fund portfolio description 26; (c) fund historical performance 27; and (d) fund literature and fact sheets 28.

From the “what's new” folder 30, the user is able to access a listing of new information, including news articles, fund performance, and various investment analyses. From either the “find/view funds” folder 20, or the “what's new” folder 30, the user is also able to download or view various information through a PDF viewer 45, as illustrated in FIG. 1. Similarly, from the “my briefcase” folder 40, the user is able to easily access detailed information about any funds or information included in his or her “briefcase” folder, and is also able to download or view such information through a PDF viewer 45.

The last folder shown in the FIG. 1 flowchart is for “multimedia” 50. From the folder or displayed page, the user is able to access and retrieve a listing of various multimedia presentations 51, which may include video presentations, such as interviews with portfolio managers, or discussions regarding current investment strategies, or other timely and relevant information that may be of interest to users. Such multimedia 51 could also, in another preferred embodiment include the option for a live “chat” with a portfolio manager or advisor. Further shown in FIG. 1 is the ability to email 55 to other users information from the multimedia presentations 51 through a multimedia player 52.

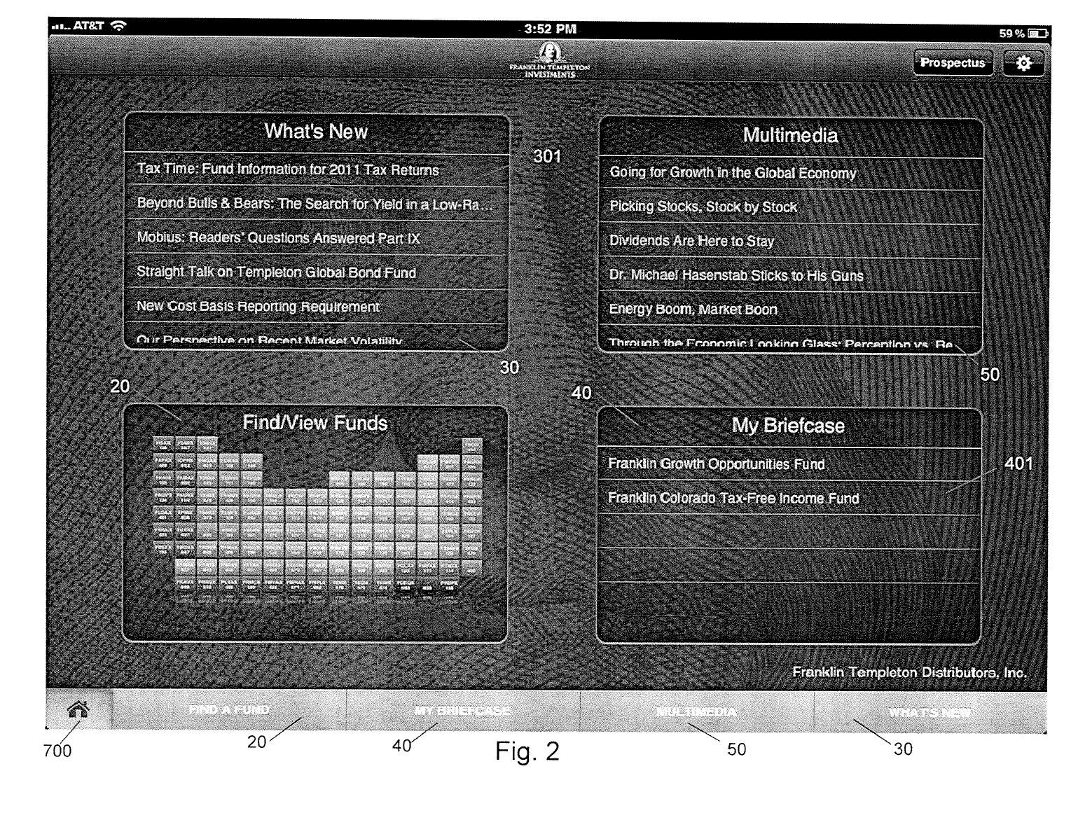

The FIG. 2 page displays illustrate an example embodiment of the “folders” which may be accessed by users of the inventive method, process and system. The four “folders” shown in FIG. 2 relate to the four “folders” shown in the FIG. 1 flow chart, and provide further exemplary detail as to the type of information which may be included within the “what's new” folder 30, “find/view funds” folder 20, “my briefcase” folder 40, and the “multimedia” folder 50. As shown in FIG. 2, the “what's new” folder 30 can provide links 301 for the user to access current and historical articles about yield information or other systems, such as TurboTax. Similarly, the “my briefcase” folder 40 can provide links 401 to the particular funds stored within the user's “briefcase” folder 40.

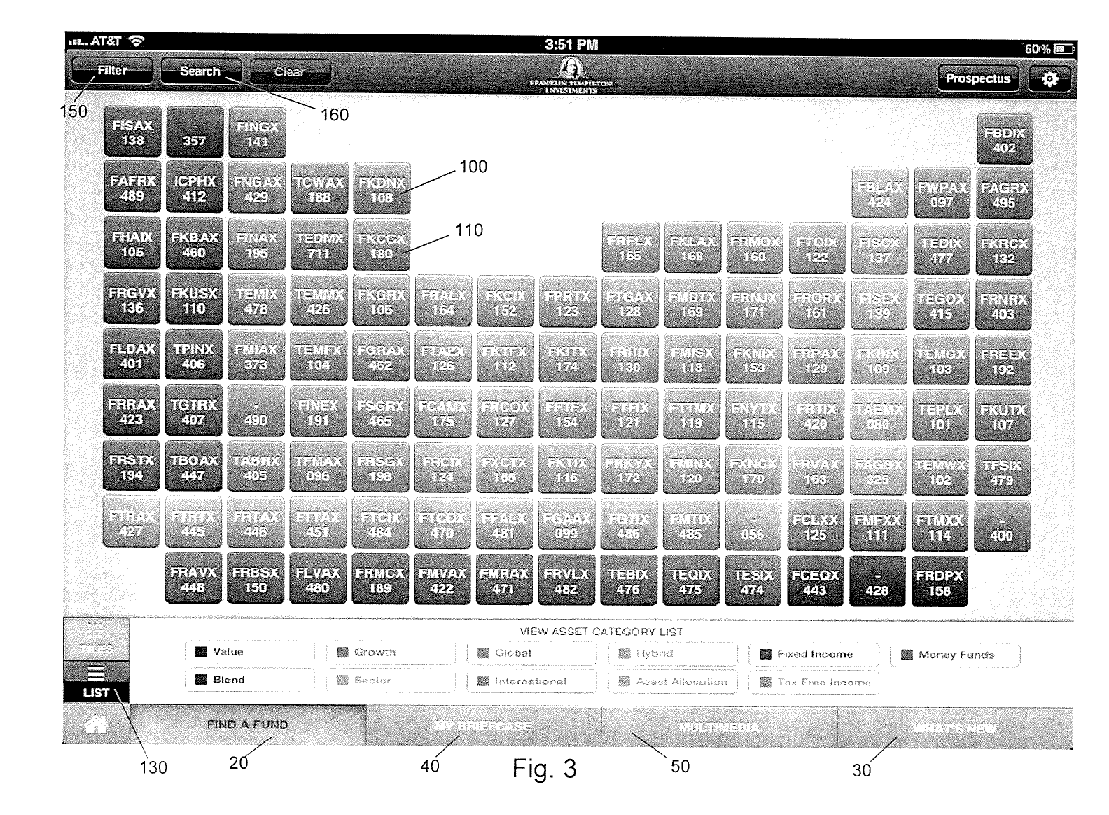

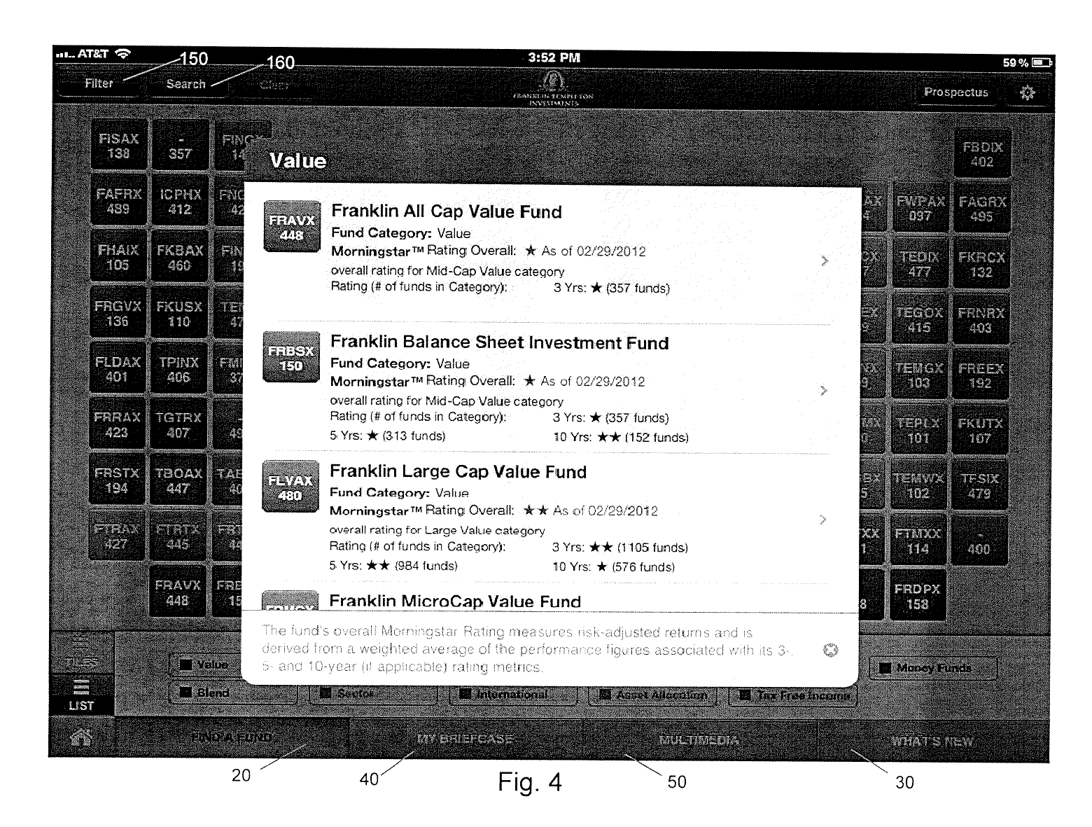

For ease of navigation for the user, as shown in FIG. 2 (and carried through to FIGS. 3 through 11) a home link 700 may be provided to allow the user to quickly return to the system home page. Similar to the “home” link shown in the lower left hand corner of the displays, the user may also be provided with quick links to the primary four folders, as shown at the bottom of FIGS. 3 and 4, to “find a fund” 20, “my briefcase” 40, “multimedia” 50, and “what's new” 30.

In other exemplary embodiments, shown in the example screens/displays of FIGS. 2 through 11, a “Prospectus” tab could be included, to permit the user to readily download a prospectus for any fund presented within the system. Similarly, other tabs or links could be provided through a “cog” design to access a drop down menu to permit the use to connect to other relevant links, such as “Contact Us,” “About,” “Find a Financial Advisor,” “Privacy Policy,” and “Terms of Use.” Other relevant links could also be added to this drop-down selection.

### The Periodic Table of Fund Elements

FIG. 3 shows a preferred exemplary display presented to a user accessing the “find/view funds” folder 20. The display, as shown, is an innovative, color coded matrix, presented in the form of the scientific periodic table of elements. As shown by the FIG. 3 display, each of the “elements” or “tiles” 100 relate to a different fund. By selecting an element or tile 100, the user will be able to retrieve information about that fund. The “elements” or “tiles” 100 may be, in the shown preferred embodiment, color-coded. As shown in the “view asset category” legend presented at the bottom of FIG. 3, the user is easily and readily able to associate, through the color-coding, whether a fund is categorized as value (red), growth (light blue), blend (black), sector (orange), global (dark orange), international (dark blue), hybrid (green), asset allocation (grey), fixed income (navy blue), tax-free income (dark green) or money funds (dark brown). Obviously these colors are only shown by way of example and other colors may be used for the different asset categories.

The numbers shown in each of the tiles 100 presents the fund's number 110. This number 110 allows financial professionals to quickly find and request a specific fund's detailed information.

As also shown in FIG. 3, the user may also “list” 130 out available funds by selecting the list funds icon, shown in the lower left hand corner of the exemplary display. By selecting the “list” funds link 130, the user can access those funds available within a particular asset category. The listing is merely another format for displaying and presenting the information to the user. By way of one example, FIG. 4 shows an example listing of certain funds within the asset category of “value” funds.

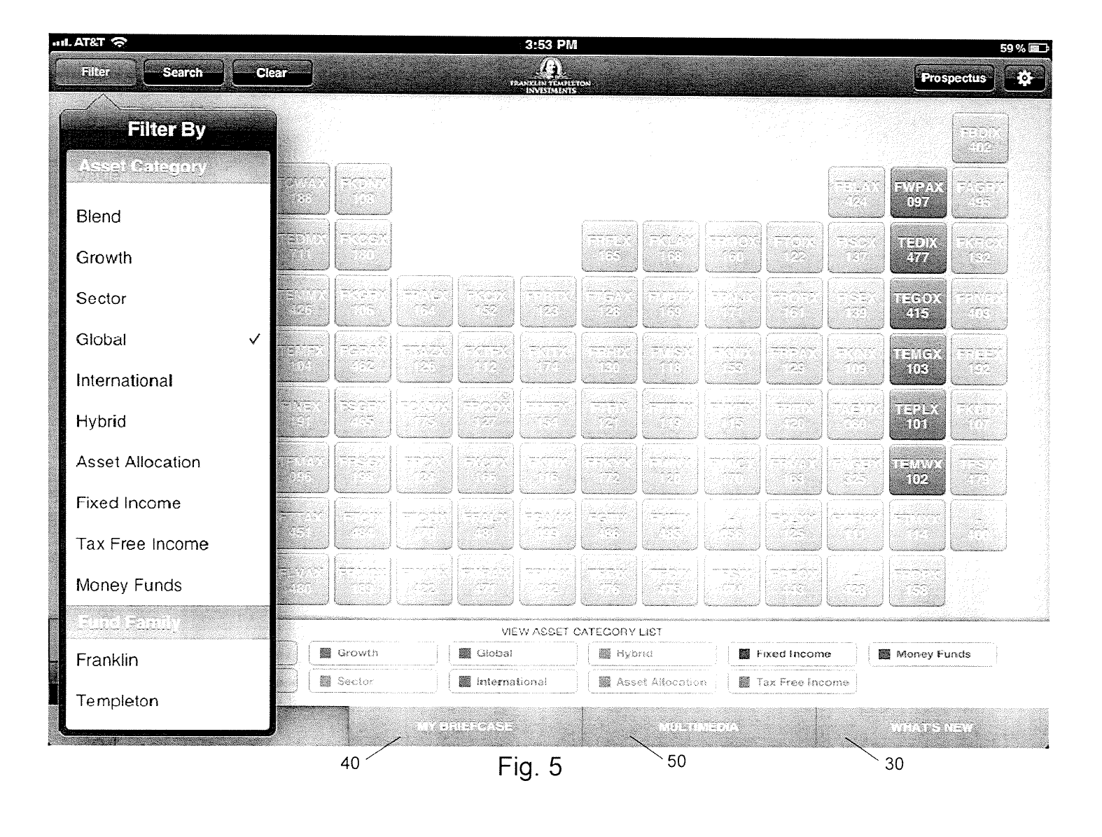

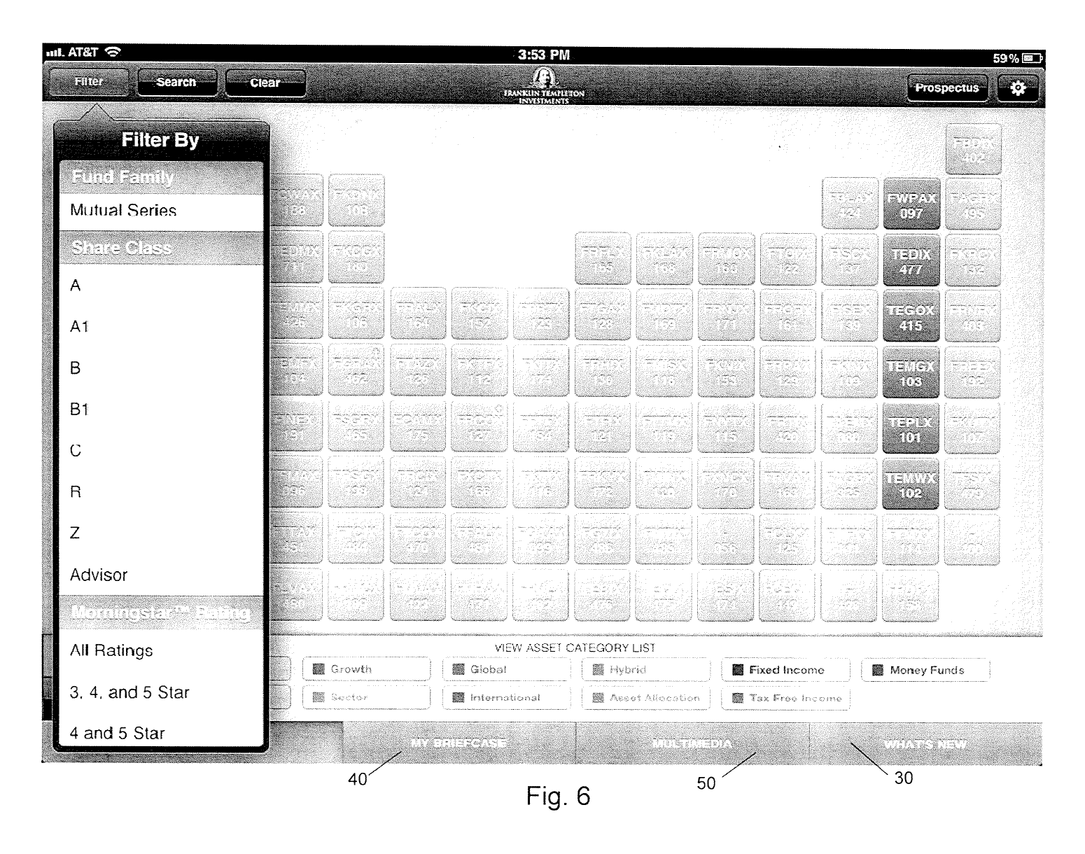

From the FIG. 3 display, a user is able to quickly review the available fund options, and can, directly from the FIG. 3 display, easily filter to a particular type of funds of interest to the user. For example, by selecting the “filter funds” option 150, shown in the upper left hand corner of FIG. 3, the user may then filter to a particular asset category, fund family name, share class and/or rating. This filtering may be implemented and displayed, in a preferred embodiment as shown in FIGS. 5 and 6. Next to the “filter funds” link, as shown in FIGS. 3 and 4, is another link to “search” funds 160 that may be included in a preferred embodiment of the inventive method and process.

The drop-down window shown in FIG. 5 illustrates the user's selection of “global” as the asset class filter. Further, FIGS. 5 and 6 show the “elements” 100 or funds retrieved through the filter highlighting in color only the “global” funds, while funds outside the filter criteria (here being other than “global” funds) may be displayed in a lighter grayscale (as in FIGS. 5 and 6), or may be not shown on the display at all (not shown). In a preferred embodiment, an icon or notation could be provided on the display of the selected “active filters,” so the user readily can see which filters are active resulting in the retrieved and displayed “elements” or funds 100.

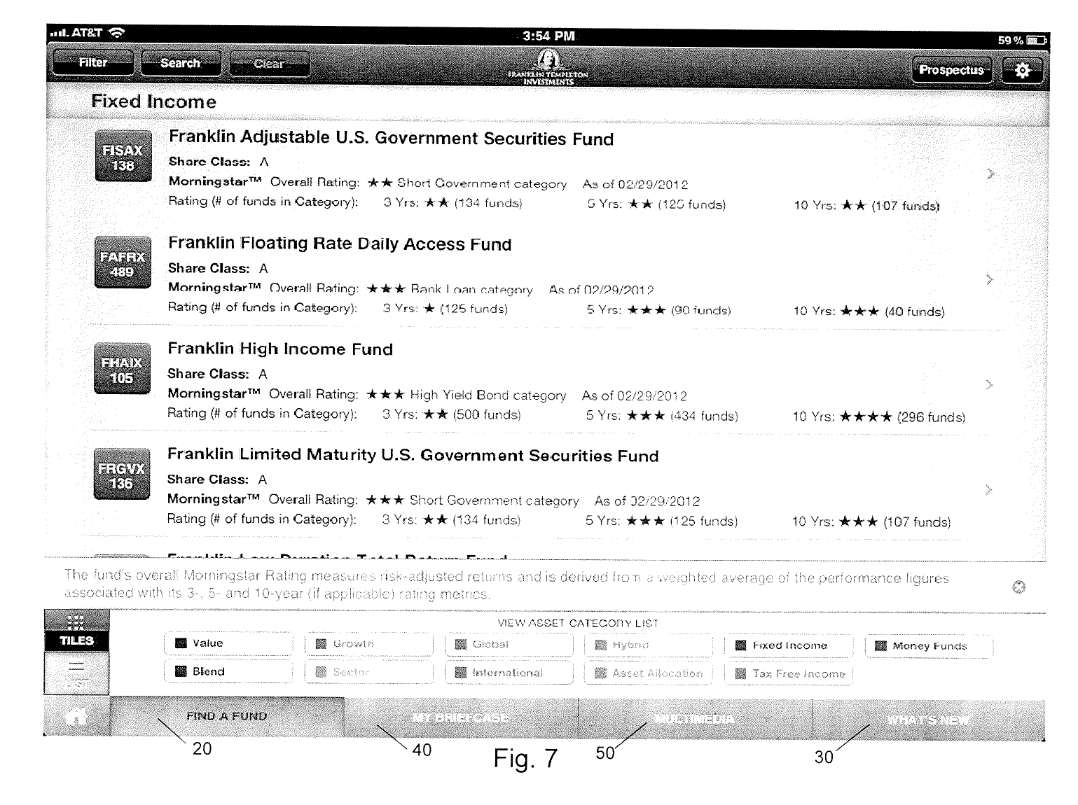

FIG. 7 shows an exemplary embodiment of a listing of funds filtered according to the “income” asset category, being “fixed income” and “tax free income,” and showing further detailed information about those retrieved funds. Such information, may include, in addition to the share class, the fund category, and the fund's ratings over time. Further information could also be shown in the listing if selected by the user.

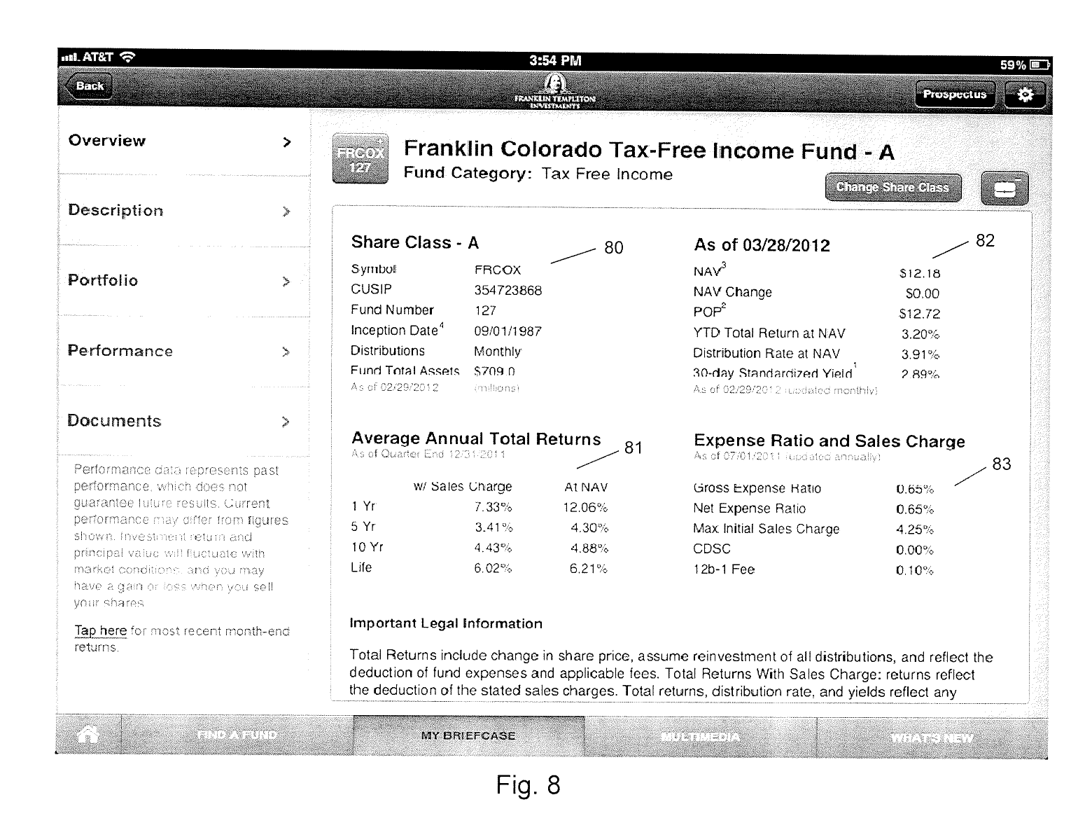

As illustrated in the exemplary embodiments of FIGS. 8 through 11, the user is also able to select further detailed information about any of the specific funds 100. FIG. 8 shows an example of fund overview of detailed information to include the type of share class 80, the average annual total returns 81, the current net asset value (“NAV”) 82, and the expense ratio 83.

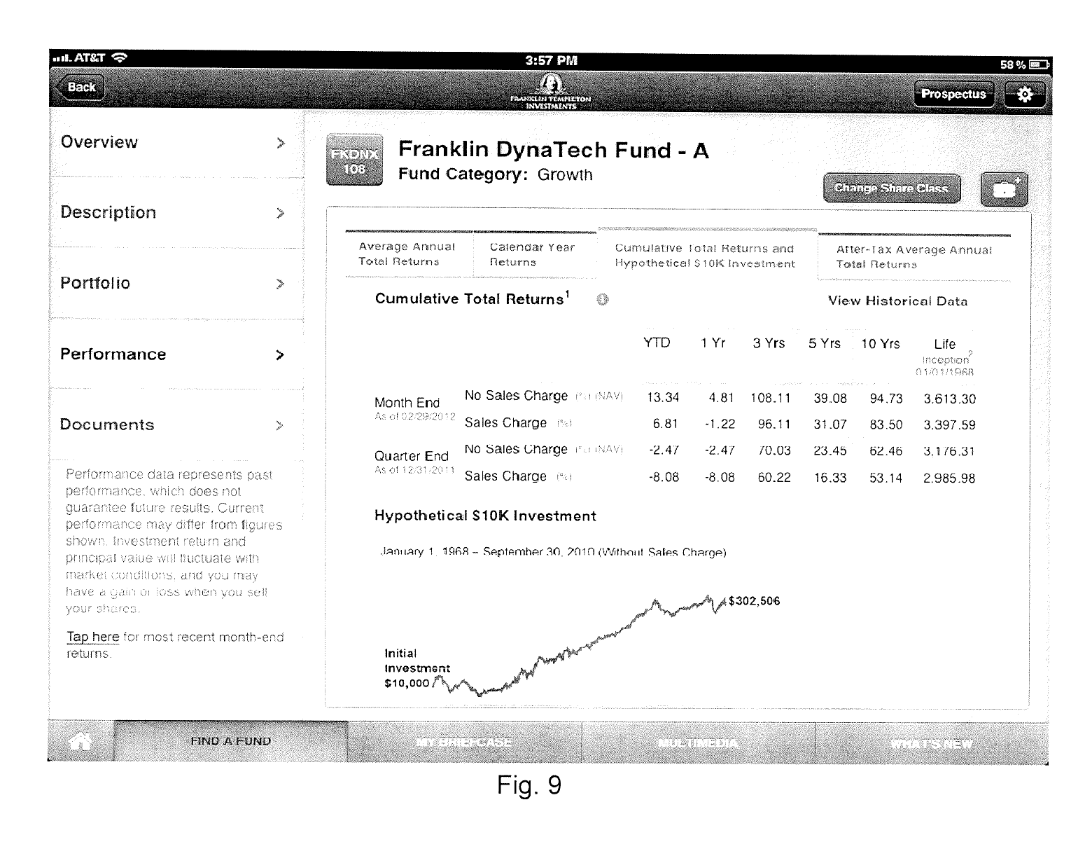

FIG. 9 shows further information and detail about a selected fund 100, obtained by selecting the “Performance” tab. As shown in FIG. 9, a graphical timeline of fund performance may be presented, as well as showing other performance details. Such information may be presented on a single page that may be scrolled through to see the information, or in another embodiment of the method and process, the user may select and link to separate page displays to show performance information in graphs or charts based on additional criteria such as after-tax average annual returns, cumulative returns on a hypothetical investment, calendar year returns and average annual total returns.

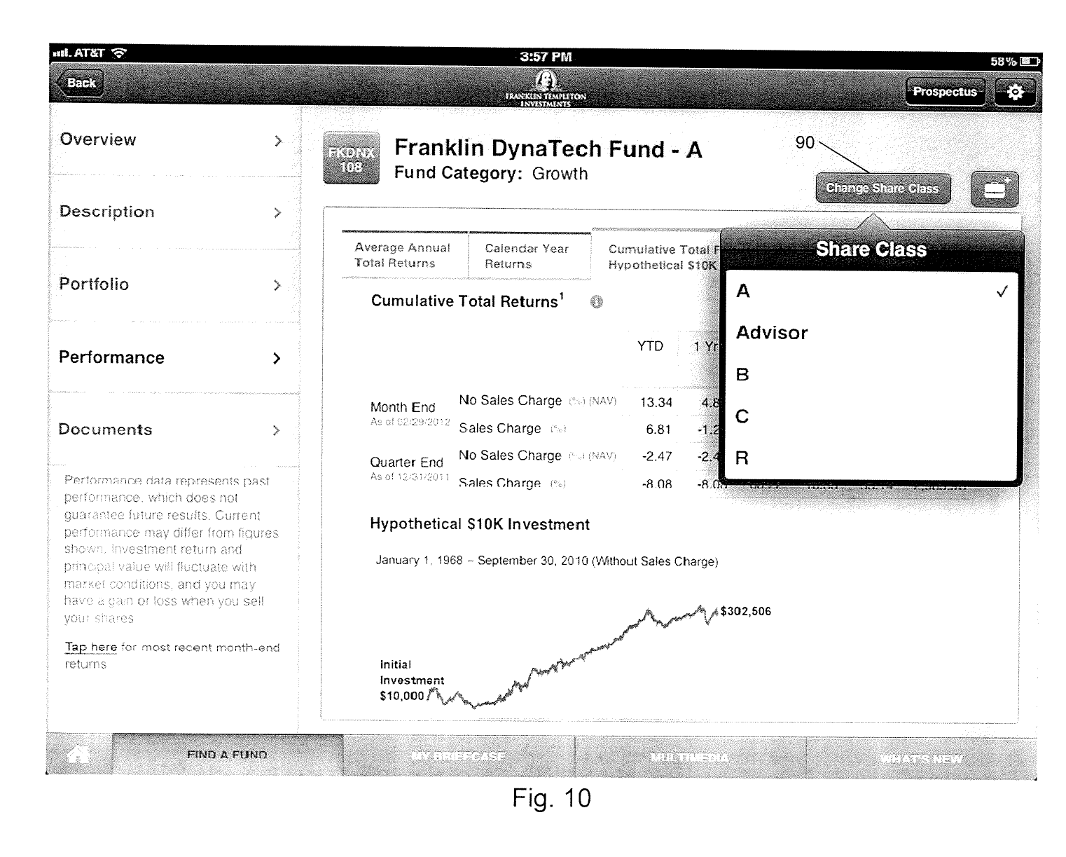

FIG. 10 shows how the user may access further information, including by changing the share class 90 of interest to the user. By selecting the “change share class” button 90, shown in the upper right hand corner of FIG. 10, a drop-down window allows the user to select other available share classes related to that fund. As shown in FIG. 10, share class A has been currently selected.

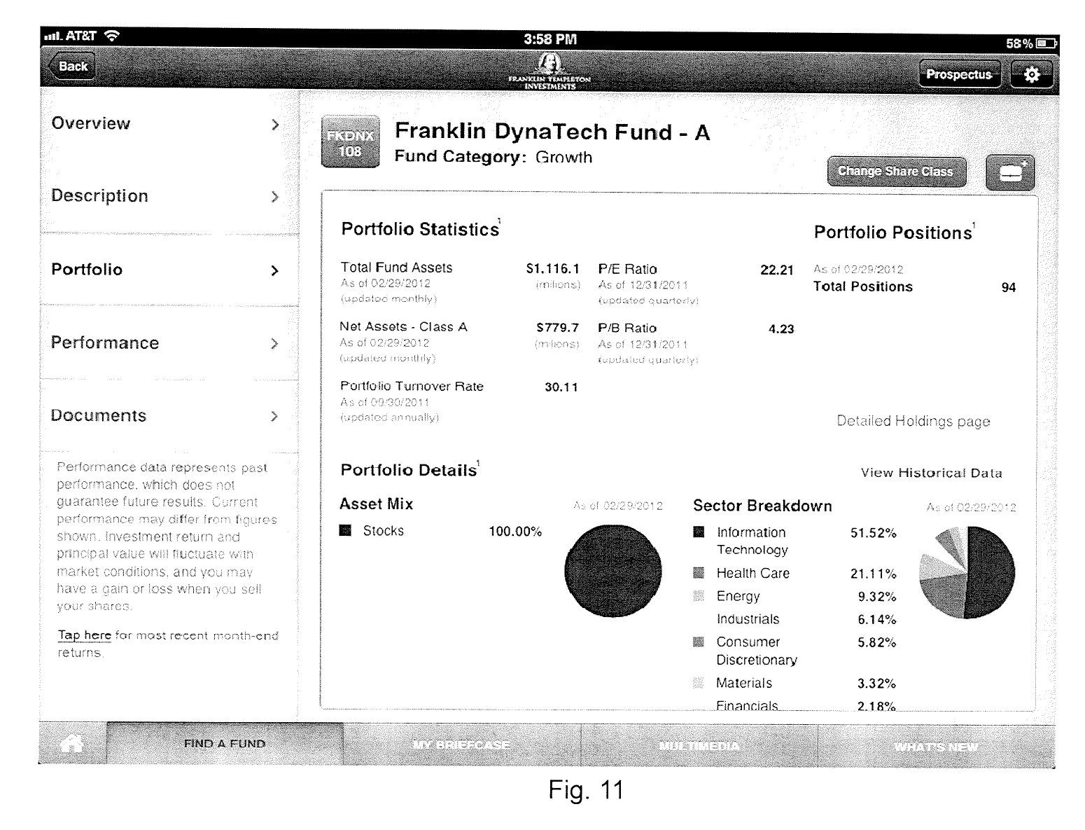

The FIG. 11 display shows an exemplary embodiment for presenting still further detailed fund information, including portfolio statistics, portfolio positions and additional portfolio details including a fund's significant holdings, industrial and geographical breakdowns and the asset mix. Again, such information may be presented on a single page that may be scrolled through to see the information, or in another embodiment of the method and process, the user may select and link to separate page displays to show the portfolio breakdown, or the top holdings within a particular fund.

The flow and steps permitting users to link between the FIGS. 8 through 11 displays, are as shown in the FIG. 1 flowchart. More particularly, as shown in FIG. 1 (on the right hand side of FIG. 1), the FIG. 8 through 11 displays may be accessed through either the FIG. 3 “periodic table” 70 or through the “fund filter” 22, and then through the “fund details” filter 23.

At the present time, there does not appear to be a method, process or system available for creatively and innovatively displaying and researching investment fund information, including through a wireless, mobile device, such as a tablet or smartphone. Accordingly, the described invention represents a new and highly valuable tool for investors and financial professionals for viewing, analyzing and marketing financial investment information.

While certain exemplary embodiments have been disclosed and described, there are other method and process variations and other system configurations that may provide for an interactive method for displaying and analyzing investment information relating to investment funds, that are equally possible and which use the method steps and system elements and architecture as disclosed herein. Such equivalent configurations are deemed fully within the scope of the claimed inventive methods and systems for an interactive display and analysis investment information method and system. Those having ordinary skill in the art and access to the teachings provided herein will recognize additional modifications, applications, embodiments and substitution of equivalents all of which are within the scope of the invention. Accordingly, the invention is not to be considered as limited by the foregoing description.

What is claimed is:

1. An interactive computerized method for displaying and analyzing investment information relating to investment funds, using at least one computer processor, and at least one database communicatively connected to the at least one computer processor, the method comprising the steps of:
(a) identifying a plurality of investment funds to be displayed, with said plurality of investment funds each having related investment fund data and information;
(b) uploading said plurality of investment fund data and information to the at least one database;
(c) organizing said plurality of investment fund data and information into a plurality of displays, including a fund home page;
(d) displaying said plurality of investment fund data and information organized in said plurality of displays in an interactive format;
(e) selecting at least one filter relating to said plurality of investment funds;
(f) applying said selected at least one filter relating to the investment funds; and
(g) updating said plurality of displays based upon the selected and applied at least one filter relating to the investment funds.

2. The interactive computerized method for displaying and analyzing investment information relating to investment funds, according to claim 1, wherein the fund home page of the plurality of displays uses a periodic table of elements format to present a portion of the investment fund information.

3. The interactive computerized method for displaying and analyzing investment information relating to investment funds, according to claim 2, wherein the periodic table of elements format for the fund home page is color coded as a function of asset category.

4. The interactive computerized method for displaying and analyzing investment information relating to investment funds, according to claim 1, wherein said plurality of investment fund data and information is updated on a real-time basis.

5. The interactive computerized method for displaying and analyzing investment information relating to investment funds, according to claim 1, wherein said plurality of investment fund data and information includes at least one of fund overview, portfolio breakdown, asset allocation, and historical performance data.

6. The interactive computerized method for displaying and analyzing investment information relating to investment funds, according to claim 1, further comprising the step of (h) creating a user-defined portfolio of user selected investment funds and investment fund information.

7. The interactive computerized method for displaying and analyzing investment information relating to investment funds, according to claim 1, further comprising the step of (h) providing further live data feed information relating to said plurality of investment funds.

8. The interactive computerized method for displaying and analyzing investment information relating to investment funds, according to claim 7, wherein said further live data feed information is a live conversation with an investment advisor.

9. The interactive computerized method for displaying and analyzing investment information relating to investment funds, according to claim 7, wherein said further live data feed information is interactive information presented through a webcast.

10. The interactive computerized method for displaying and analyzing investment information relating to investment funds, according to claim 7, wherein said further live data feed information is interactive information presented through video streaming.

11. The interactive computerized method for displaying and analyzing investment information relating to investment funds, according to claim 7, wherein said further live data feed information is interactive information presented through audio streaming.

12. An interactive marketing and information retrieval system for use in displaying and analyzing investment information relating to investment funds, comprising:
at least one computer processor; and
at least one database communicatively connected to the at least one computer processor;
wherein said at least one computer processor executes the following method steps:
(a) identifying a plurality of investment funds to be displayed, with said plurality of investment funds each having related investment fund data and information;
(b) uploading said plurality of investment fund data and information to the at least one database;
(c) organizing said plurality of investment fund data and information into a plurality of displays, including a fund home page;
(d) displaying said plurality of investment fund data and information organized in said plurality of displays in an interactive format;
(e) selecting at least one filter relating to said plurality of investment funds;
(f) applying said selected at least one filter relating to the investment funds; and
(g) updating said plurality of displays based upon the selected and applied at least one filter relating to the investment funds.

13. The interactive marketing and information retrieval system for use in displaying and analyzing investment information relating to investment funds, according to claim 12, wherein the fund home page of the plurality of displays uses a periodic table of elements format to present a portion of the investment fund information.

14. The interactive marketing and information retrieval system for use in displaying and analyzing investment information relating to investment funds, according to claim 13, wherein the periodic table of elements format for the fund home page is color coded as a function of asset category.

15. The interactive marketing and information retrieval system for use in displaying and analyzing investment information relating to investment funds, according to claim 12, wherein said plurality of investment fund data and information is updated on a real-time basis.

16. The interactive marketing and information retrieval system for use in displaying and analyzing investment information relating to investment funds, according to claim 12, wherein said plurality of investment fund data and information includes at least one of fund overview, portfolio breakdown, asset allocation, and historical performance data.

17. The interactive marketing and information retrieval system for use in displaying and analyzing investment information relating to investment funds, according to claim 12, further comprising the step of (h) creating a user-defined portfolio of user selected investment funds and investment fund information.

18. The interactive marketing and information retrieval system for use in displaying and analyzing investment information relating to investment funds, according to claim 12, further comprising the step of (h) providing further live data feed information relating to said plurality of investment funds.

19. The interactive marketing and information retrieval system for use in displaying and analyzing investment information relating to investment funds, according to claim 18, wherein said further live data feed information is interactive information presented through a webcast.

20. The interactive marketing and information retrieval system for use in displaying and analyzing investment information relating to investment funds, according to claim 18, wherein said further live data feed information is interactive information presented through video streaming.
